(19) United States
(12) Patent Application Publication
(10) Pub. No.: US 2012/0072475 A1
(43) Pub. Date: Mar. 22, 2012

(54) MEASURING "CLOSENESS" IN A NETWORK

(76) Inventors: Gregory C. Morrison, Woburn, MA (US); Lakshminarayanan Mahadevan, Brookline, MA (US)

(21) Appl. No.: 13/230,496

(22) Filed: Sep. 12, 2011

Related U.S. Application Data
(60) Provisional application No. 61/381,474, filed on Sep. 10, 2010.

(51) Int. Cl. G06F 15/00

(52) U.S. Cl. 708/200

(57) ABSTRACT

Closeness between nodes in a weighted network may be measured using an asymmetric generalization of classical Erdös numbers.

### CROSS-REFERENCE TO RELATED APPLICATION

This application claims priority to and the benefit of, and incorporates herein by reference in its entirety, U.S. Provisional Patent Application No. 61/381,474, which was filed on Sep. 10, 2010.

### FIELD OF THE INVENTION

The present invention relates, generally, to systems and methods for measuring the closeness between nodes in a network.

### BACKGROUND

A variety of complex natural and artificial systems can be viewed as networks, with a set of nodes representing objects and a set of edges connecting these nodes representing interactions between objects. Such systems include protein or metabolic networks, networks modeling disease propagation in populations, computer networks and the world wide web, and networks of human or animal interactions. Measuring the “closeness” or “similarity” between nodes in a network can be useful for characterizing basic, intrinsic features of the network as well as network development. For example, friendships in social networks and their evolution in time may be quantified based on some measure of closeness. Additionally, measurements of the closeness of nodes within a biological network may improve our understanding of bioinformatics or biological evolution. Further, a closeness or similarity measure can serve as a basis for predicting attributes of new nodes in a growing network, e.g., predicting ratings of new products based on prior ratings of similar products.

Various metrics of the distance between nodes in an undirected network (i.e., a network in which each edge connects a pair of nodes in both directions and, if weighted, has the same weight associated with each direction) have been developed, including, for example, the integer distance (which corresponds to the classic Erdös numbers) and the resistance distance. Erdös numbers were originally created to describe the level of collaboration between the mathematician Paul Erdös and his colleagues in a co-authorship network; they measure the topological distances of the nodes (which represent, e.g., the various authors) from a “central” or “distinguished” node (e.g., Paul Erdös) in integer values. For example, Erdös himself has Erdös number E=0; any person directly connected to Erdös has E=1; and any person directly connected to a person with Erdös number 1 has E=2, and so on. Thus, Erdös numbers measure the length of the shortest path between any two nodes. The topological distances in a network are, however, not necessarily integers. For example, the edges may have non-integer weighting factors (or “weights”) associated with them, where the weighting factors indicate the strength of the interaction or connection between the two nodes. The resulting shortest-path distances generally have non-integer values. In an alternative approach, the distance between nodes may be measured by modeling each edge of the network as an electrical resistor (whose resistance may be set to be the inverse of the weight associated with the respective edge), and calculating the overall electrical resistance between any two nodes of interest (using, e.g., Kirchhoff's law). The value of the resistance distance thus computed is usually a non-integer number, as is the value of the inverse of the resistance distance, which characterizes the closeness between the nodes.

Other metric measures of the distance between two nodes can be used, such as the overlap and Jacard coefficients. These measures all define the distance between nodes A and B in terms of the nodes they are both connected to. The overlap coefficient between A and B is simply the number of nodes they have in common (O_{AB}=|C_{A}∩C_{B}|, where C_{A} and C_{B} are the nodes that A and B are connected to, respectively), and the Jacard coefficient is the overlap coefficient divided by the total number of nodes connected to A and B (J_{AB}=O_{AB}|C_{A}∪C_{B}|). These methods are an improvement over the simplistic integer Erdös numbers, but do not take the full network topology into account (as the resistance distance does).

Both integer distance and resistance distance are symmetric measures of the distance (and, thus, the closeness) between two nodes, i.e., the closeness felt by node A towards node B is the same as the closeness felt by node B towards node A. However, the closeness felt between two nodes in a real-world network is not always mutually the same. For example, in a social network, person A may feel very close to person B if A is directly connected to B and to only few other people. However, person B, who has many friends, may feel less close to person A, because his attention is divided between many friends. Therefore, closeness defined in terms of the integer distance or resistance distance does not characterize the intrinsic features of this social network very well. This may result in unreliable predictions for new nodes added to the network that are derived from such traditional closeness measurements.

Other methods for determining the distance or closeness of two nodes based on topological considerations of the network are available. For example, clustering analysis breaks the network into connected subsets (clusters); the nodes in each subset are similar in some sense. Both symmetric and asymmetric distances can be utilized to determine the closeness of two nodes. However, while clustering analysis is useful in determining blocks of nodes that are close to one another, it cannot, in general, determine the closeness of nodes within an individual cluster.

Accordingly, there is a need for alternative measures of closeness that are applicable between any two nodes of a network and facilitate capturing non-mutual aspects of closeness.

### SUMMARY

In various embodiments, the present invention relates to systems and methods for characterizing the closeness of a distinguished (or designated) node to other nodes in a network using a real-valued, asymmetric measure of closeness, hereinafter referred to as “Generalized Erdös Numbers” (GENs). Since any node of the network may be selected as the distinguished node, the GENs may serve to measure the closeness of any node of the network to any other node. For each selected distinguished node, the GENs of other nodes may be computed recursively based on the GENs of their nearest neighbors in the network (i.e., the nodes to which they are directly connected), taking the strength of the connections to the nearest neighbors (i.e., the weights associated with the connecting edges) into account. As used herein, the term “weight” refers to the strength of the direct connection (i.e., the edge) between adjacent nodes (i.e., nearest neighbors) in the network. The term “closeness,” on the other hand, refers to a separation between any two nodes in the network that takes the connection of the nodes to additional nodes into account. (This separation is not in physical space, but characterizes, for example, the ability of two nodes to communicate.) For example, in a computer network, the edge between two nodes (i.e., computers) may represent their ability to exchange data via a direct link. The weight may represent the data exchange rate across that link. The two computers may, however, exchange data simultaneously via their direct link and via indirect connections through other computers. The closeness between the two nodes may then represent the overall speed at which they communicate with one another, which generally depends on the number of the available data transfer paths and the data transfer rate along these paths. In a social context, the weight may quantify, for example, the number of communications between two people (which become adjacent nodes by virtue of the communications). The closeness between two people within the network may represent the ability of the first person to get in contact with the second person, via a direct communication if appropriate or via introduction or referral by one or more third parties, and may depend on the relationship of the first person with her nearest neighbors in the network and on these nearest neighbors' closeness to the second person.

The interaction between nodes may also depend on the availability of shared or finite resources, which may influence the ability of nodes to rapidly communicate. For example, an individual may be able to communicate with many friends instantaneously via email or some other mode of rapid communication. However, if his or her physical presence is required to interact with other people, he or she must divide up a finite amount of time between multiple people. Likewise, in a computer network, the CPU may need to perform lengthy calculations on received messages before sending them on to other machines in the network (where the CPU can perform a finite number of operations per unit time). In these cases, nodes with few connections generally communicate readily with their neighbors, whereas well-connected nodes use their finite resources to communicate with many neighbors. The communication pathways between nodes depend on the global structure of the network (which can be described by the resistance distance or other global metrics), but also depends on the fact that resources are shared (which is not easily described using the resistance distance or other global metrics).

A network of N nodes can be characterized by an N×N-matrix (the “adjacency matrix”) whose elements ij correspond to the weights assigned to respective edges between node i and node j (where an unconnected pair of nodes can be thought of as connected by an edge having a weight of zero). For an undirected network (i.e., a network whose edges connect pairs of nodes in both directions), the adjacency matrix is symmetric. The GENs, however, are generally asymmetric even if the underlying adjacency matrix is symmetric; they thereby facilitate more realistic characterization of the interactions—e.g., the closeness—between nodes in a network. In various embodiments, the GENs are deployed to predict high-order information about the structure of the network (e.g., the effect of adding new nodes and links to the network). For example, in one embodiment, ratings of nodes newly added to a network are predicted based on known ratings of the other nodes and the GENs between the old and new nodes.

Accordingly, in one aspect, the invention pertains to a method of computing closeness between pairs of nodes of a network. The method includes: (i) storing weights associated with edges of the network in computer memory, (ii) initializing values of the closeness of the nodes to a designated node and storing the resulting values in the computer memory, and (iii) using a computer processor, updating the resulting closeness value for each node based on the closeness values of the nodes connected thereto and the weights associated with the connecting edges.

In one embodiment, the method includes repeating the updating step. In another embodiment, the method comprises successively selecting different nodes as the designated node and repeating the initializing and updating steps for each selected designated node. In various implementations, successively selecting different nodes involves successively selecting each node of the network as the designated node.

In some embodiments, updating the closeness value of each node includes computing an average over the nodes that connect to the node. In one embodiment, the average is an average of a function of respective sums of closeness values and inverses of the weights. In one implementation, the average is a weighted harmonic average, and the weights associated with the connecting edges, scaled by a sum thereof, constitute weighting factors of the weighted harmonic average. In another implementation, the average comprises a weighted sum of powers of the respective sums of closeness values and inverses of the weights; the weighted sum may satisfy the equation:

$${E}_{MN}^{- α} = {W}_{N}^{- 1} ( β ) {\sum }_{{P}_{i} ∈ {C}_{N}} {( \frac{{w}_{{NP}_{i}}^{β}}{{E}_{{MP}_{i}} + {w}_{{NP}_{i}}^{- 1}} )}^{α} ,$$

where M denotes the designated node, E is the closeness value of node N to node M, Pᵢ denotes the nodes connected to node N, E_{MPi} are the closeness values of nodes Pᵢ to node M, w_{NPi} are the weights associated with respective edges connecting node N to nodes Pᵢ,W_{N}(β) is the sum of the weights w_{NPi}, raised to the β, C_{N} denotes a set of the nodes connected to node N, and α and β are free parameters.

In various embodiments, the average comprises a weighted sum of exponentials of the respective sums of closeness values and inverses of the weights; the weighted sum may satisfy the equation:

$${e}^{- {λE}_{MN}} = {W}_{N}^{- 1} ( β ) {\sum }_{{P}_{i} ∈ {C}_{N}} {w}_{{NP}_{i}}^{β} {e}^{- λ ( {E}_{{MP}_{i}} + {w}_{{NP}_{i}}^{- 1} )}$$

where M denotes the designated node, E_{MN} is the closeness value of node N to node M, Pᵢ denotes the nodes connected to node N, E_{MPi} are the closeness values of nodes Pᵢ to node M, w_{NPi} are the weights associated with respective edges connecting node N to nodes Pᵢ,W_{N} is the sum of the weights w_{NPi}, C_{N} denotes a set of the nodes connected to node N, and λ is a free parameters.

In one embodiment, the method includes computing the weights associated with the edges of the network. Further, the method may involve computing a rating associated with the designated node based, at least in part, on ratings associated with other nodes. In various embodiments, computing the rating associated with the designated node comprises computing an average of the ratings associated with the other nodes weighted by a function of the closeness values of the other nodes to the designated node. The function may be monotonically decreasing in the closeness values. In another implementation, the average comprises a Boltzmann weighted average or a weighted arithmetic average.

In a second aspect, the invention relates to a system for computing closeness between pairs of nodes of a network. The system includes: (a) computer memory for storing (i) weights associated with edges of the network, and (ii) values of the closeness of the nodes to a designated node, and (b) a computer processor for (i) initializing the closeness values, and (ii) updating the closeness value for each node based on the closeness values of the nodes connected thereto and the weights associated with the connecting edges. In some embodiments, the processor is further configured to compute the weights associated with the edges of the network.

In a third aspect, the invention relates to a computer-readable medium storing computer-executable instructions for computing closeness between nodes in a weighted network. In various embodiments, the instructions include: (i) instructions for initializing values of the closeness of the nodes to a designated node, and (ii) instructions for updating the closeness value for each node based on the closeness values of the nodes connected therewith along edges and weights associated with the connecting edges.

### BRIEF DESCRIPTION OF THE DRAWINGS

In the following description, various embodiments of the present invention are described with reference to the following drawings, in which:

FIG. 1 is a block diagram of a system for executing closeness measurements according to the invention.

FIG. 2A depicts a simple linear network.

FIG. 2B depicts a more complex network.

FIG. 2C is a flow chart illustrating an iterative method of computing GENs in accordance with one embodiment.

FIG. 3 is a graph of GENs computed in accordance with one embodiment, illustrating that the closeness felt by M towards N may be different from that felt by N towards M.

FIG. 4 is a flow chart illustrating a method in accordance with one embodiment for predicting user ratings of movies based on prior ratings by other users and for optimizing prediction parameters.

FIG. 5A depicts the root mean square deviation error of the movie-rating predictions obtained with the method of FIG. 4 against baseline predictions as a function of a free parameter β.

FIG. 5B illustrates an improvement of the movie-rating predictions obtained with the method of FIG. 4 as a function of the number of movies seen for a fixed value of β.

### DETAILED DESCRIPTION

### I. System for Executing Closeness Measurements

Measurements of closeness in accordance with the invention, and applications based thereon, can be carried out efficiently with a computer system. The system can be an individual computer, or a network of computers connected, for example, via the Internet, an intranet, and/or a local or wide area network. If a network is utilized, the computational load can be distributed over multiple computers. In some embodiments, one or more computers are designated as servers which carry out certain functionalities, and the remaining computers are clients. However, this distinction need not apply to all embodiments. Depending on the particular application, some implementations may be preferred over others.

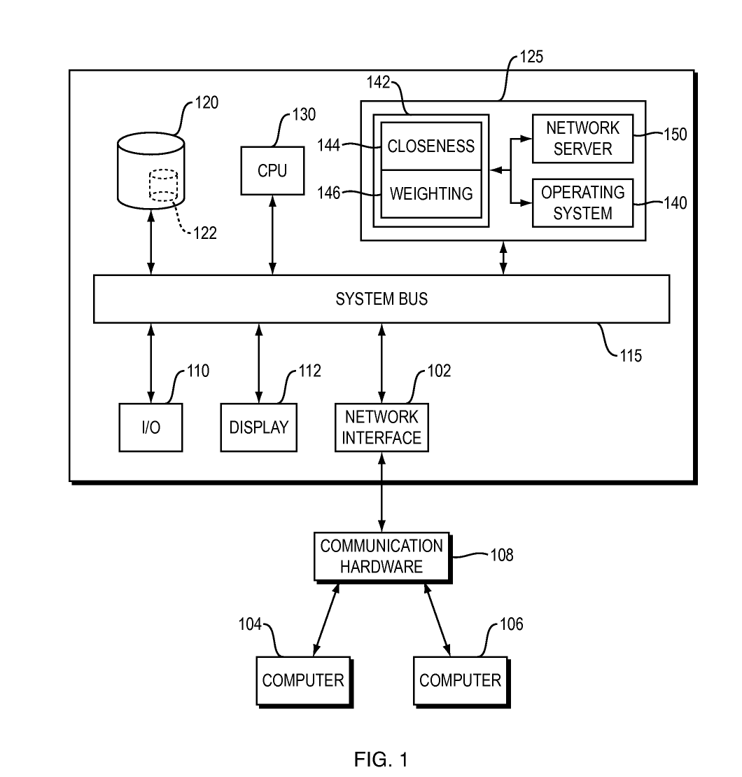

FIG. 1 illustrates, in block-diagram form, an exemplary computer 100 with features enabling it to perform closeness measurements in accordance herewith, as well as its integration into a network. The computer 100 includes a network interface 102, which interacts with other computers 104, 106 of the network via communication hardware 108. The computer 100 also includes input/output devices 110 (e.g., a keyboard, a mouse or other position-sensing device, etc.), by means of which a user can interact with the system, and a screen display 112. The computer 100 further includes a bidirectional system bus 115, over which the system components communicate, a non-volatile mass storage device (such as one or more hard disks and/or optical storage units) 120, which can contain one or more databases 122 representing the nodes to be ranked, and a main (typically volatile) system memory 125. The operation of computer 100 is directed by a central-processing unit (“CPU”) 130.

The main memory 125 contains instructions, conceptually illustrated as a group of modules, that control the operation of CPU 130 and its interaction with the other hardware components. An operating system 140 directs the execution of low-level, basic system functions such as memory allocation, file management and operation of mass storage devices 120. At a higher level, a service application 142, which integrates a closeness module 144 with a weighting module 146, carries out the closeness measurements of the invention. More specifically, the weighting module may compute and/or assign weights to the edges of a network, and the closeness module may compute GENs characterizing the closeness between nodes of the network based on, among other things, the assigned weights. The weights and/or GENs may be stored within main memory 125 and/or in the mass storage device 120, e.g., within the database 122. The service application 142 may include one or more additional, application-specific modules (not shown) for analyzing and characterizing the network based on the GENs computed with the closeness module 144. The service application 142 can receive requests (for assigning weighting factors or measuring closeness) directly from another application or a user of computer 100, or from other computers 104, 106 of the network. To enable the handling of requests from computers 104, 106, the main memory 125 contains a network-server block 150. If the network is the Internet, for example, block 150 can be a conventional web server application.

### II. Closeness Measurements

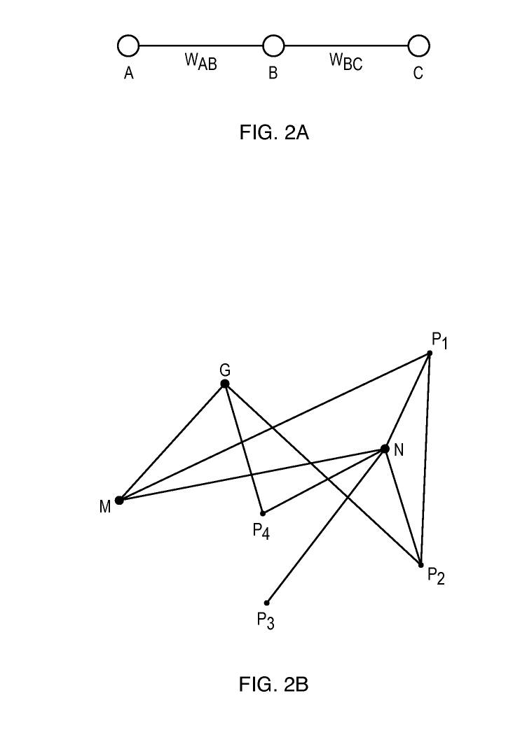

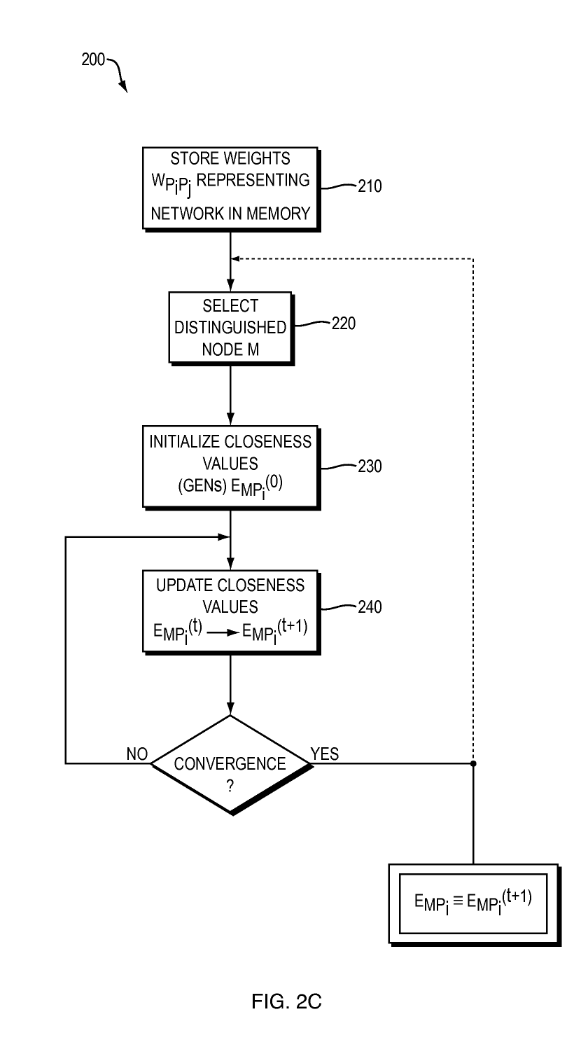

GENs in accordance herewith may be defined recursively based on the GENs of their nearest neighbors, generally in conjunction with the weights associated with the edges to the nearest neighbors. This can be illustrated with reference to simple exemplary networks, as shown in FIGS. 2A and 2B. FIG. 2A depicts a linear network of three nodes A, B, and C. Selecting A as the distinguished node, the closeness of node A to itself, E_{AA}, is zero, as is the case with conventional distance metrics. The closeness E_{AC} that node C, which connects to A via exactly one other node, B, as depicted in FIG. 2A, feels towards node A may be defined as: E_{AC}=E_{AB}+w_{BC}⁻¹, with E_{AB} being the closeness “felt” by node B towards node A and w_{BC} being the weight of the edge joining B and C (i.e., the strength of the connection between B and C). (The term “feel” or “felt” is herein used for simplicity to describe connections, and connotes the degree of closeness experienced by the node in question—whether or not that experience involves human emotion or actual “feelings”; the nodes, of course, may be computers, with closeness referring to a network attribute such as communication speed or topological proximity.)

In various embodiments, referring to FIG. 2B, the closeness that node N feels to a designated node M in a complex network can be generalized as:

E_{MN}=h_{N}({E_{MP}_{ᵢ}+w_{NP}_{ᵢ}⁻¹}) (1),

for M≠N, where Pᵢ are all the nodes that have direct connections to node N, and E_{MP}_{ᵢ}+w_{NP}_{ᵢ}⁻¹ is the closeness node Pᵢ feels to Min the absence of all other edges connected thereto. The function h_{N} of |C_{N}| arguments (with |C_{N}| being the number of nodes N is connected to) can be chosen to have virtually any functional form, so long as h_{N} is (a) increasing with any increasing argument E_{MP}_{ᵢ}+w_{NP}_{ᵢ}⁻¹, (b) remains finite as any argument goes to infinity, and (c) is unchanged if the arguments are permuted. With these choices, the closeness (or GEN) that N feels to M thus depends on the connectivity of N (i.e., the number of direct connections N has) and the weight of each edge connected with N. (Note that the GEN E_{MN} of node N does not depend on node G, to which it is not connected.) In various embodiments, nodes that feel close to M contribute more than nodes that feel far from M when computing E_{MN}, and connections with high weight have a higher contribution than those with low weights, since closeness between two nodes depends on their connectivity (i.e., the number of their connections) to other nodes and the strength (i.e., the weights) of the connections.

The functional dependence of the GEN of N on the sums of respective GENs of its neighbors and the associated edge weights may take various forms. In one embodiment, the closeness of node N to node M is determined using a weighted harmonic mean:

$$\frac{1}{{E}_{MN}} = \frac{1}{{W}_{N}} {\sum }_{{P}_{i} ∈ {C}_{N}} \frac{{w}_{{NP}_{i}}}{{E}_{{MP}_{i}} + {w}_{{NP}_{i}}^{- 1}} , \qquad ( 2 )$$

where W_{N} is the strength of node N, W_{N}=Σ_{P}_{ᵢ}w_{NP}_{ᵢ}, and C_{N} the set of nodes directly connected to node N. The GENs E_{MP}_{ᵢ} are thus defined recursively by a set of coupled non-linear equations (2), which may be solved iteratively, as illustrated in FIG. 2C. The iterative method 200 involves representing the network in terms of the weights w_{P}_{ᵢ}_{P}_{ⱼ} between nodes Pᵢ and Pⱼ, which may be saved in computer memory (step 210). Next, one of the nodes is selected as the distinguished node M (step 220). To compute an iterative solution for the GENs E_{MP}_{ᵢ}, initial values E_{MP}_{ᵢ}⁽⁰⁾ are assigned (step 230), and updated values E_{MP}_{ᵢ}^{(t)} are then obtained based on, among other things, the values E_{MP}_{ᵢ}^{(t-1)} of previous iterations (step 240), e.g., using equation (2). The updating step 240 may be repeated until a predetermined convergence criterion is satisfied, e.g., until the maximum change of the GENs in successive iterations, max_{N}|E_{MP}_{ᵢ}^{(t)}−E_{MP}_{ᵢ}^{(t-1)}|, is less than a specified threshold value, e.g., 0.01. The iterative computation of GENs may be repeated for other selections of the distinguished nodes. The method 200, thus, allows numerically computing the closeness of a node to any other node in an arbitrary network based on the connectivity and weights of the connections in the network.

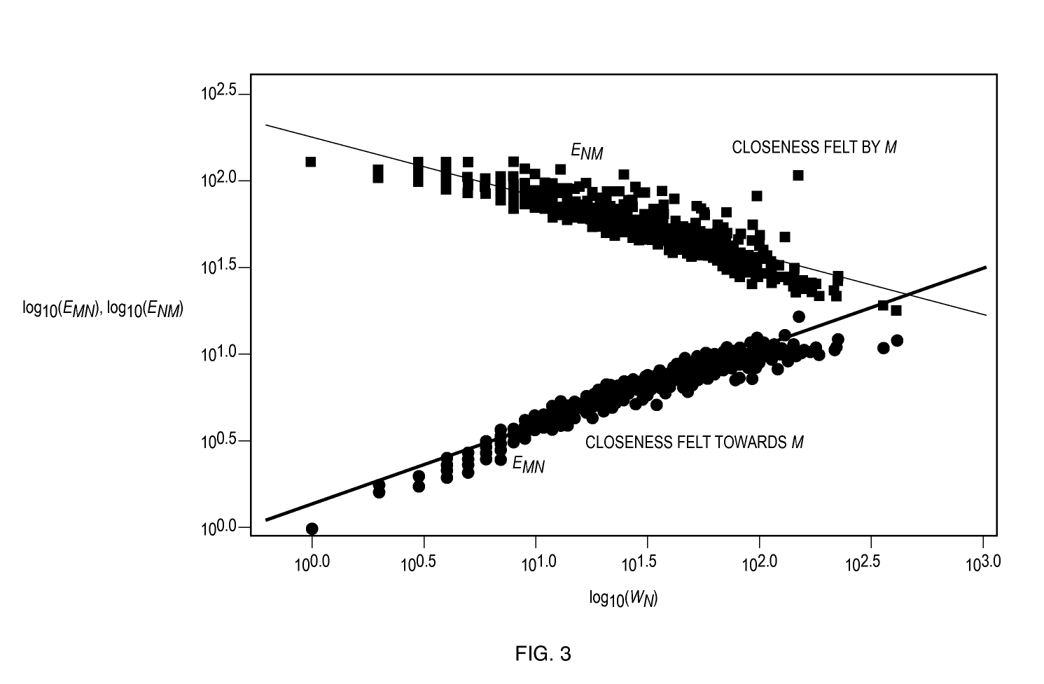

GENs capture the characteristics of closeness in many real-world networks. For example, in a social network, people who have very few friends (i.e., W_{N}˜1) may feel very close to a person M (i.e., E_{MN} is smaller) since they are connected directly to M and few other nodes. People having many friends (i.e., W_{N}>>1) feel less close to M (i.e., E_{MN} is larger) because their attention is divided between a large number of friends. This relationship between E_{MN} and W_{N} is shown in FIG. 3 by the circles. On the other hand, the closeness felt by M towards his friends (i.e., E_{NM}) has the opposite behavior: M is less close (i.e., E_{NM} is larger) to friends with few friends (i.e., W_{N}˜1), because his attention is divided between many friends, but is closer (i.e., E_{NM} is smaller) to friends with more friends (i.e., W_{N}>>1) because of the many paths between them. This relationship is captured by the squares in FIG. 3. The asymmetry captured by the GENs, with E_{MN}≠E_{NM}, is not discernible using a distance metric such as the integer distance between nodes, which is necessarily symmetric.

Further, in a fully connected network of X+1 nodes of constant interaction strength w_{P}_{ᵢ}_{P}_{ⱼ}=w(1−δ_{P}_{ᵢ}_{P}_{ⱼ}), where δ_{P}_{ᵢ}_{P}_{ⱼ} is the Kronecker delta (which is 1 for Pᵢ=Pⱼ and 0 otherwise), each node has the same GEN (i.e., E_{MP}_{ᵢ}=E for Pᵢ≠M), with the equivalent of (2) given by

$$\frac{wX}{E} = {w}^{2} + \frac{{w}^{2} ( X - 1 )}{wE + 1} , \qquad ( 3 )$$

yielding E=\sqrt{X}/w. This indicates that, as the strength w of each connection between nodes increases, the GENs of all nodes decrease (i.e., the nodes feel closer to each other). However, as the number of nodes increases, with edges added to keep the network fully connected, the importance of an individual edge is lessened and the nodes will feel less close to one another. This is consistent with the relationship in a social network: As the strength of the connection increases, M and N feel closer to each other. However, they feel less close to each other when they have more friends, since the finite amount of time they have is shared with many friends. This feature of GENs stands in contrast to other distance measures, such as the resistance distance, which decreases as new nodes are added, or the integer distance, which remains constant independent of X. The GENs thus provide a better approach to characterizing certain real-world networks.

The closeness measure defined above may be modified in various ways. For example, in one embodiment, the GENs are defined as:

$${E}_{MN}^{- α} = {W}_{N}^{- 1} ( β ) {\sum }_{{P}_{i} ∈ {C}_{N}} {( \frac{{w}_{{NP}_{i}}^{β}}{{E}_{{MP}_{i}} + {w}_{{NP}_{i}}^{- 1}} )}^{α} , \qquad ( 4 )$$

where W_{N}(β)=Σ_{P}_{ᵢ}w_{NP}_{ᵢ}^{β}, and where α and β are parameters that may be tuned to adjust the degree to which the GENs depend on the weights. In another embodiment, the GENs are defined as weighted averages of exponentials of the nearest-neighbor GENs and associated weights:

$${e}^{- {λE}_{MN}} = {W}_{N}^{- 1} ( β ) {\sum }_{{P}_{i} ∈ {C}_{N}} {w}_{{NP}_{i}}^{β} {e}^{- λ ( {E}_{{MP}_{i}} + {w}_{{NP}_{i}}^{- 1} )} , \qquad ( 5 )$$

where β and λ are adjustable parameters. Alternative functional dependencies are possible, with a general form of

$$f ( {E}_{MN} ) {\sum }_{{P}_{i} ∈ {C}_{N}} g ( {w}_{{NP}_{i}} ) = {\sum }_{{P}_{i} ∈ {C}_{N}} g ( {w}_{{NP}_{i}} ) f ( {E}_{{MP}_{i}} + {w}_{{NP}_{i}}^{- 1} )$$

where f(x) is a monotonically decreasing function of x and g(x) is a monotonically increasing function of x. In general, various unique features of GENs, such as their asymmetry, are retained as long as the GEN for each node is expressed as a function of the sums of the GENs of its nearest neighbors and the weights associated with the connecting edges.

### III. Applications

The present invention may be used to analyze and characterize the connectivity of a network and/or the closeness between nodes within the network based on given strengths (i.e., weights) associated with connections between the nodes. By suitably defining the weights of the network edges, the invention may be applied to many different types of networks. Further, by allowing the weights to be time-dependent, the dynamics of the network may be captured. GENs in accordance herewith may also serve as a basis for deducing higher-order information about the structure of the network, and/or for making predictions about the ranks or characteristics of certain nodes based on corresponding known ranks or characteristics of other nodes that are close to the nodes at issue.

Exemplary applications of the methods described herein include, for example, (1) the prediction of movie, book, or song ratings or genres based on previous ratings (using, e.g., data available from NetFlix, iTunes, or Amazon); (2) the characterization of the evolution of friendships in social networks (e.g., Facebook, LinkedIn, or MySpace), where a time-dependent weight may be defined based on the number of direct interactions between users; (3) the characterization of the evolution of intellectual pursuits in scientific publications, using co-authorship networks where the eights correspond to the number of joint publications between authors; (4) the estimation of the closeness of two or more public companies, where the weight may be based on the number of direct sales or loans between companies; (5) the determination of the evolutionary closeness between two species, where the weights are based on the similarity of genotypes and/or phenotypes of the species; (6) the evaluation of chemical network data, e.g., to discern a dominant reaction pathway in a network of chemical reactions where the free-energy barriers between reactants and products serve as weighting factors; and (7) the prediction of patient responses to particular therapies or medications based on their similarity to other, previously treated patients (as determined, e.g., using geographical location, similar symptoms, and/or similar diagnoses).

In one embodiment, the GENs are used to predict user ratings, e.g., of movies, based on previous ratings of the movies by other users. In this application, the users correspond to the nodes of a network, and the similarity of the users' movie preferences determines the weights of the network edges, as further described below. The rating pᵢ^{(l)} that user i is predicted to give to movie l may be determined based on the ratings rⱼ^{(l)} that users j have previously given to movie l according to:

$${p}_{i}^{( l )} = {\sum }_{j ∈ {S}_{l}} {r}_{j}^{( l )} {h}_{β} ( {E}_{ij} ) / {\sum }_{j ∈ {S}_{l}} {h}_{β} ( {E}_{ij} ) , \qquad ( 6 )$$

where Eᵢⱼ is the GEN between users i and j, h_{β}(Eᵢⱼ) is a monotonically decreasing function of Eᵢⱼ with an adjustable parameter β that allows for optimization, and Sₗ is the set of users j that have rated movie l.

The function h_{β}(Eᵢⱼ) may take various forms. In one embodiment, the GENs are utilized to characterize an “interaction energy” between users i and j, and the rating Pᵢ^{(l)} are defined by the Boltzmann-weighted average:

$${p}_{i}^{( l )} = {\sum }_{j ∈ {S}_{l}} {r}_{j}^{( l )} {e}^{- \overline{ω} β {E}_{ij}} / {\sum }_{j ∈ {S}_{l}} {e}^{- \overline{ω} β {E}_{ij}} , \qquad ( 7 )$$

where ω̅ is the average weight over the weights assigned to all edges and β is a free parameter that describes how important distant nodes are in determining the predicted rating. In another embodiment, the rating Pᵢ^{(l)} is defined as a weighted arithmetic average of previous ratings of users j, where the inverse of the GENs constitute the weights:

$${P}_{i}^{( l )} = ( {\sum }_{j ∈ {S}_{l}} \frac{{r}_{j}^{( l )}}{{E}_{ij}^{( β )}} ) / ( {\sum }_{j ∈ {S}_{l}} \frac{1}{{E}_{ij}^{( β )}} ) \qquad ( 8 )$$

To compute Eᵢⱼ, each user is assumed to connect to other users through the movies that they have rated. For example, the strength of the connection may be defined as:

$${w}_{ij} = {\sum }_{l ∈ {M}_{ij}} {( 5 - \vert Δ {r}_{ij}^{( l )} \vert )}^{α} , \qquad ( 9 )$$

with Δrᵢⱼ^{(l)}=rᵢ^{(l)}−rⱼ^{(l)}, where rᵢ^{(l)} is the rating user i has given to movie l (0≦|Δrᵢⱼ^{(l)}|≦4) and Mᵢⱼ is the set of movies that both i and j have rated. Implicit in this definition is that users who seek out the same movies have more similar tastes than those who do not even if they do not agree), and that users who agree on movies are more likely to have similar tastes than those who disagree. The free parameter α determines the importance of agreement: α=0 implies that disagreement in the ratings are irrelevant, while α→∞ implies that agreement in the ratings is dominant.

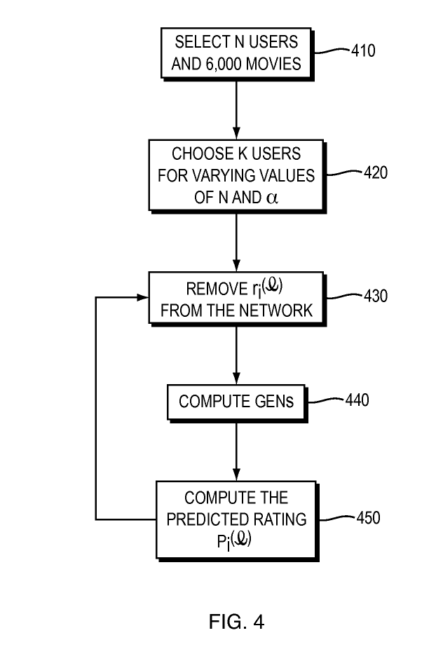

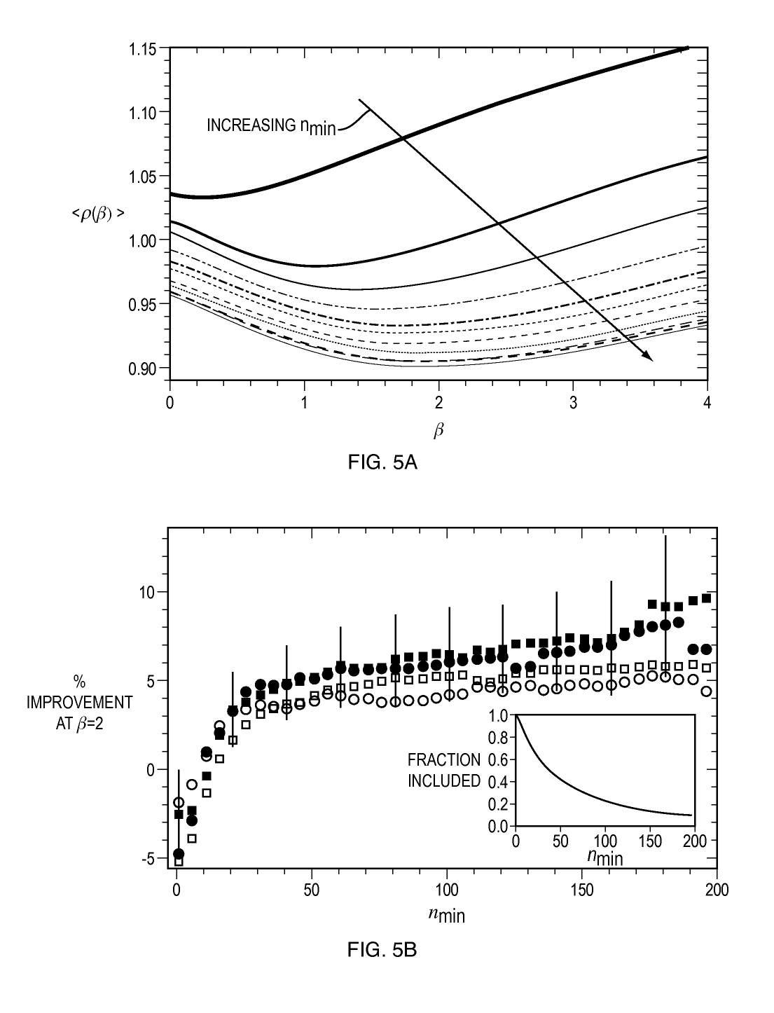

The prediction scheme described above may be tested, for example, on a subset of the publicly available NetFlix dataset, as illustrated in the flow chart of FIG. 4. To do so, a subset of the full NetFlix dataset, e.g., comprising N users and 6000 movies, is first selected (step 410). In step 420, k users are chosen from the data set for varying values of N and the free parameter α, which affects the importance of agreement between user ratings in the prediction scheme. The rating that user i has previously given to movie l is removed from the network in step 430. The GENs for this modified network are then computed (e.g., using any of equations (2), (4), or (5)) in step 440. In step 450, the predicted rating pᵢ^{(l)} that user i gives to movie l is then computed, using equation (7), as a function of Step 430, 440, and 450 are iteratively performed for each node. The accuracy of the prediction may be characterized in terms of the root mean square deviation (RMSD) between the original and the predicted ratings of all movies l that the user i has seen. As illustrated in FIG. 5A, the RMSD strongly depends on, and decreases with, the number of movies nᵢ that the user has seen. This dependence is not surprising since the preferences of users who have seen very few movies will be much more difficult to predict. FIG. 5A also illustrates the effect of the free parameter β on the quality of the prediction. In general, β may have a different values for different networks. Here, the optimal value is β=2, as shown in FIG. 5A. The predicted ratings computed in accordance herewith may be compared against a baseline prediction obtained by simple averaging over predictions by other users (which corresponds to β=0 in equations (7) and (8)). Referring to FIG. 5B, about a 5-10% improvement over the baseline average can be obtained using this approach for the NetFlix data for well connected nodes (where the minimum number of movies nₘᵢₙ that users have seen exceeds about 50). The GENs are thus able to make quantitative predictions on real-world data. The GEN-based prediction scheme may be supplemented with other methods for data prediction, which may increase the utility of this approach.

In one embodiment, data representing a network, for example, a network of interlinked computers, is entered into the system using an I/O device 110. The weighting module 144 of service application 142 may assign weights to the edges of the network (i.e., the links between the computers), and cause storage of the weights in memory 125 and/or in mass storage device 120. Closeness module 146 may then determine closeness between the nodes in accordance with the above-described techniques. Specifically, closeness module 144 may compute GENs for each node as a function of the GENs of its nearest neighbors and the weights associated with the connecting edges (e.g., in accordance with any of equations (2), (4), or (5)). The GENs may be stored along with other data representing the network within main memory 125 and/or mass storage device 120. The service application may include one or more additional application-specific modules for analyzing and characterizing the network based on the GENs computed with the closeness module 144.

It is important to note that the systems and techniques described herein need not be stand-alone. Rather, the GENs described herein may be supplemented by, or combined with, other measures of closeness or distance between nodes. Further, the present approach can be used in conjunction with many different well-developed methods for characterizing networks and determining correlations or distances between the nodes within a network. Clustering algorithms may efficiently break the network into highly correlated clusters, and the present approach may be used to determine more detailed properties of each cluster.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A method for computing closeness between pairs of nodes of a network, the method comprising:
storing weights associated with edges of the network in computer memory;
initializing values of the closeness of the nodes to a designated node and storing the resulting values in the computer memory; and
using a computer processor, updating the resulting closeness value for each node based on the closeness values of the nodes connected thereto and the weights associated with the connecting edges.

2. The method of claim 1, further comprising repeating the updating step.

3. The method of claim 1, further comprising successively selecting different nodes as the designated node and repeating the initializing and updating steps for each selected designated node.

4. The method of claim 3, wherein successively selecting different nodes comprises successively selecting each node of the network as the designated node.

5. The method of claim 1, wherein updating the closeness value of each node comprises computing an average over the nodes connected therewith.

6. The method of claim 5, wherein the average is an average of a function of respective sums of closeness values and inverses of the weights.

7. The method of claim 6, wherein the average is a weighted harmonic average.

8. The method of claim 7, wherein the weights associated with the connecting edges, scaled by a sum thereof, constitute weighting factors of the weighted harmonic average.

9. The method of claim 6, wherein the average comprises a weighted sum of powers of the respective sums of closeness values and inverses of the weights.

10. The method of claim 9, wherein the weighted sum satisfies the equation:
$${E}_{MN}^{- α} = {W}_{N}^{- 1} ( β ) {\sum }_{{P}_{i} ∈ {C}_{N}} {( \frac{{w}_{{NP}_{i}}^{β}}{{E}_{{MP}_{i}} + {w}_{{NP}_{i}}^{- 1}} )}^{α} ,$$
where M denotes the designated node, E_{MN} is the closeness value of node N to node M, Pᵢ denotes the nodes connected to node N, E_{MPi} are the closeness values of nodes Pᵢ to node M, w_{NPi} are the weights associated with respective edges connecting node N to nodes Pᵢ, W_{N}(β) is the sum of the weights w_{NP} raised to β C_{N} denotes a set of the nodes connected to node N, and α and β are free parameters.

11. The method of claim 1, wherein the average comprises a weighted sum of exponentials of the respective sums of closeness values and inverses of the weights.

12. The method of claim 11, wherein the weighted sum satisfies the equation:
$${e}^{- λ {E}_{MN}} = {W}_{N}^{- 1} ( β ) {\sum }_{{P}_{i} ∈ {C}_{N}} {w}_{{NP}_{i}}^{β} {e}^{- λ ( {E}_{{MP}_{i}} + {w}_{{NP}_{i}}^{- 1} )} ,$$
where M denotes the designated node, E_{MN} is the closeness value of node N to node M, Pᵢ denotes the nodes connected to node N, E_{MPi} are the closeness values of nodes Pᵢ to node M, w_{NPi} are the weights associated with respective edges connecting node N to nodes Pᵢ, W_{N} is the sum of the weights w_{NPi} raised to the β, C_{N} denotes a set of the nodes connected to node N, and λ is a free parameters.

13. The method of claim 1, further comprising computing the weights associated with the edges of the network.

14. The method of claim 1, further comprising computing a rating associated with the designated node based, at least in part, on ratings associated with other nodes.

15. The method of claim 14, wherein computing the rating associated with the designated node comprises computing an average of the ratings associated with the other nodes weighted by a function of the closeness values of the other nodes to the designated node.

16. The method of claim 15, wherein the function is monotonically decreasing in the closeness values.

17. The method of claim 15, wherein the average comprises a Boltzmann weighted average.

18. The method of claim 15, wherein the average comprises a weighted arithmetic average.

19. A system for computing closeness between pairs of nodes of a network, the system comprising:
(a) computer memory for storing (i) weights associated with edges of the network, and (ii) values of the closeness of the nodes to a designated node; and
(b) a computer processor for (i) initializing the closeness values, and (ii) updating the closeness value for each node based on the closeness values of the nodes connected thereto and the weights associated with the connecting edges.

20. The system of claim 19, wherein the processor is further configured to compute the weights associated with the edges of the network.

21. A computer-readable medium storing computer-executable instructions for computing closeness between nodes in a weighted network, the instructions comprising:
instructions for initializing values of the closeness of the nodes to a designated node; and
instructions for updating the closeness value for each node based on the closeness values of the nodes connected therewith along edges and weights associated with the connecting edges.
